(19) United States
(12) Patent Application Publication
(10) Pub. No.: US 2026/0056903 A1
(43) Pub. Date: Feb. 26, 2026

(54) LINK RETENTION DURING DEVICE WARM RESET

(71) Applicant: QUALCOMM Incorporated, San Diego, CA (US)

(72) Inventors: Rajashekar MANCHE, Bangalore (IN); Neha AGARWAL, New Delhi (IN); Srinivas PULICHERLA, Hyderabad (IN); Vivek Sheel MITTAL, Bangalore (IN)

(21) Appl. No.: 18/815,506

(22) Filed: Aug. 26, 2024

(51) Int. Cl. G06F 13/42

(52) U.S. Cl. CPC G06F 13/4221; G06F 2213/0026

(57) ABSTRACT

A warm reset of a device is described with retention of a link with the device. In an example, an endpoint of a device is configured to maintain a link to another node and to receive a reset command. A reset controller is configured to disconnect the endpoint of the device from a system-on-a-chip (SoC) of the device, to command a reset of the SoC after the disconnecting the endpoint, and to connect the endpoint to the SoC after the reset has been performed.

### TECHNICAL FIELD

The present application relates to a link between a device and another node, and, in particular, to retaining the link with the device during a warm reset of the device.

### BACKGROUND

Computing systems provide links between nodes to allow for processors, memory, interfaces, and peripherals to exchange data and control information. One such link is referred to a Peripheral Component Interface express (PCIe). PCIe defines a host as one node that has a Root Complex (RC) that communicates through a link to one or more other nodes, referred to as devices. Each device has an Endpoint (EP) coupled to the RC through the link. In part, the link is the physical wires, pins, leads, and other connectors that transmit the data and control information. Such a link allows the capabilities of the computing system to be expanded by connecting devices to the host.

For PCIe, each device has a separate link to the RC of the host and the host sets the configuration of each link including the speed, number of lanes and the hierarchy of each link with respect to the others. There are a variety of other types of links between components that are used in computing systems to facilitate data and control information transactions.

### BRIEF SUMMARY

The following presents a summary of one or more implementations in order to provide a basic understanding of such implementations. The invention is defined by the independent claims. More particular examples are set out in the dependent claims. Examples and aspects that do not fall within the scope of the claims are merely examples used for explanation of the invention. This summary is not an extensive overview of all contemplated implementations and is intended to neither identify key or critical elements of all implementations nor delineate the scope of any or all implementations. Its sole purpose is to present some concepts of one or more implementations in a simplified form as a prelude to the more detailed description that is presented later.

In one example an endpoint of a device is configured to maintain a link to another node. A reset controller is configured to disconnect the endpoint of the device from a system-on-a-chip (SoC) of the device in response to a reset trigger, to command a reset of the SoC after the disconnecting the endpoint, and to connect the endpoint to the SoC after the reset has been performed.

In another example, an apparatus includes means for disconnecting an endpoint of a device from an SoC of the device in response to receiving a reset command, wherein the endpoint is configured to maintain a link to another node. The apparatus further includes means for performing a reset of the SoC after the disconnecting the endpoint and means for connecting the endpoint to the SoC after the reset has been performed.

In another example a method includes receiving a reset command and disconnecting an endpoint of a device from an SoC of the device in response to the reset command, wherein the endpoint is configured to maintain a link to another node. The method further includes performing a reset of the SoC after the disconnecting the endpoint and connecting the endpoint to the SoC after the reset has been performed.

To the accomplishment of the foregoing and related ends, the one or more implementations include the features hereinafter fully described and particularly pointed out in the claims. The following description and the annexed drawings set forth in detail certain illustrative aspects of the one or more implementations. These aspects are indicative, however, of but a few of the various ways in which the principles of various implementations may be employed and the described implementations are intended to include all such aspects and their equivalents.

### BRIEF DESCRIPTION OF THE DRAWINGS

FIG. 1 is a block diagram of a computing architecture with PCIe interfaces suitable for aspects of the present disclosure.

FIG. 2 is a block diagram of a system including a host and a device according to aspects of the present disclosure.

FIG. 3 is a process and signal diagram of warm reset operations between a power supply and a device according to aspects of the present disclosure.

FIG. 4 is a signal diagram of a warm reset operation as controlled by a reset controller at a device according to aspects of the present disclosure.

FIG. 5 is a process flow diagram of a device reset according to aspects of the present disclosure according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, these concepts may be practiced without these specific details. In some instances, well-known structures and components are shown in block diagram form in order to avoid obscuring such concepts.

In a PCIe context, a Root Complex of a host provides a PCIe interface with an Endpoint (EP) of a device via a link (e.g., a PCIe link). When the PCIe link is reset, whether by the Root Complex (RC) or the Endpoint (EP), all communication is interrupted on the link. If the RC is coupled to multiple EPs via a PCIe bus including respective PCI links with each of the EPs, then all communication is stopped for all EPs while the PCIe link hierarchy is re-enumerated. Re-enumerating the PCIe hierarchy stops all operations on the PCIe bus for all devices on that bus until the process is completed. This interrupts use of at least a part of the system and there is some threat to the stability of the bus. In some instances, a PCIe link may become unstable after it is reset so that the process of resetting and re-enumeration is then repeated. The downtime and dangers of such PCIe resets is not significant for applications in which PCIe reset is rare and for which high reliability is not required.

With some server and virtual computing configurations, devices are utilized to serve client requests. Each new client instance on the same device at the server can require that the device be reset. During a typical reset, all of the resources including the EP of the device are reset so that the EP of the device does not respond to any activity on its PCIe link to the host during the reset. When the PCIe link at the EP is lost, the PCIe link with the RC of the host must also be reset after the device is back online. In some implementations, when any one PCIe link is reset, some or all of the other PCIe links with the host are reset and the PCIe hierarchy with all of the devices is re-enumerated. In some environments, e.g., a virtual cloud server environment, there may be hundreds or thousands of such new client instances in a day. When an RC of the host is coupled to many EPs, e.g. 20 or 30, then the impact on server performance through the PCIe link may be severely impacted.

To support frequent device resets, the PCIe EP of the device may be disconnected from the rest of the device during the reset. The PCIe EP of the device stays active and maintains the link independent of the rest of the device. In the event that the host RC requires a response from the EP, the EP may return protocol replies or dummy data as a reply to the host RC. After the reset is completed, then the EP may be reconnected to the rest of the device. The rest of the device is referred to herein as an SoC (System on a Chip). In this reset, the EP is separated from the SoC, then the SoC is reset, and then the EP is reconnected to the SoC. The PCIe link is maintained through the process independently of the SoC, i.e. the rest of the device.

When the PCIe link is maintained throughout the reset process, there is no need to re-initialize the PCIe link and the reset process at the SoC does not affect any other device or EP coupled to the RC.

To improve stability, the status of the SoC may be checked before it is reset. The SoC may operate in different modes including low power, standby, or sleep modes. In some examples, the SoC has an OFF state, a deep sleep state, a sleep state, and active state, and a mission mode state, among others. The present description will refer primarily to a sleep state and an active state, however, the sleep state may refer to any state other than mission mode or active states and the active state may refer to any stable state that is suitable for performing a reliable reset. In some examples, the SoC may have particular active or inactive states that are preferred for a reset sequence in which case such a state may be used as the active state in the reset process herein. The SoC may first undergo a wakeup sequence or wakeup command before the SoC reset begins. In some implementations, this ensures that the SoC is in a known stable state before the reset. The reset is blocked until after the wakeup sequence and also until after the PCIe EP is disconnected. This new process may be referred to as a Mission Mode Warm Reset (MMWR) in that the SoC is awake and in Mission Mode before it is reset. In other configurations, there may not be a state that is referred to or equivalent to a Mission Mode so that a different active state may be used for the warm reset.

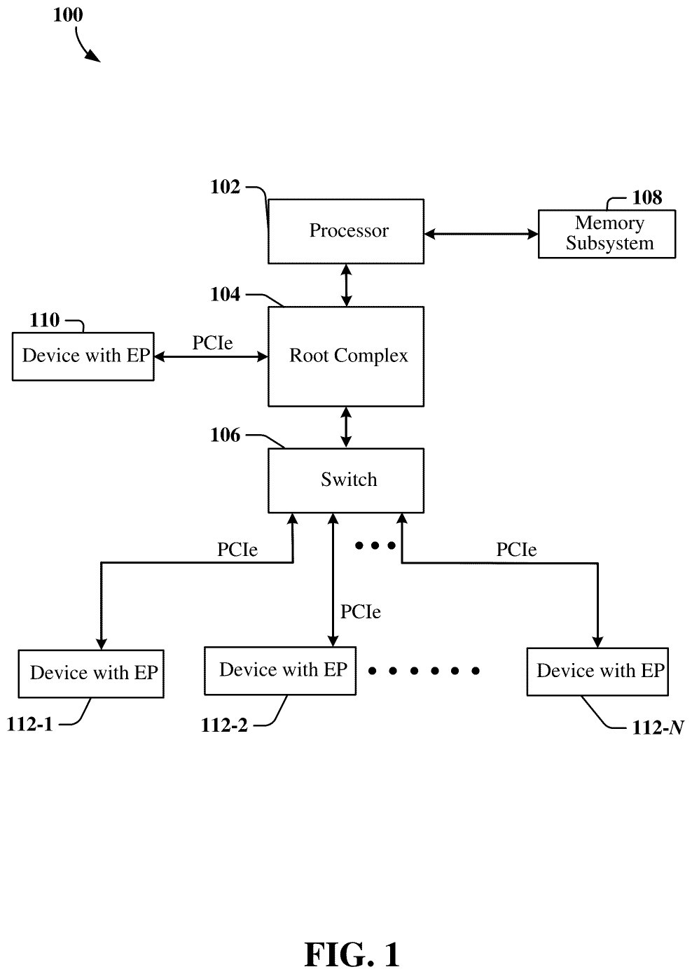

FIG. 1 is a block diagram of an example computing architecture using PCIe interfaces. The architecture may include more or fewer components depending on the particular implementation. The present description is in the context of a server system but may be applied to many different purposes. The computing architecture 100 operates using multiple high-speed PCIe interface serial links. A PCIe interface may be characterized as an apparatus including a point-to-point topology, where separate serial links connect each device to a host, through a root complex (RC) 104. In the computing architecture 100, a processor 102 is coupled to a memory subsystem 108 and to a root complex 104. The root complex 104 couples the processor 102 to a PCIe switch circuit 106 and also to one or more devices, e.g., device 110. In some instances, the PCIe switch circuit 106 includes cascaded switch devices. One or more devices 110 with a respective PCIe endpoint (EP) may be coupled directly to the root complex 104, while other devices 112-1, 112-2 . . . 112-N with PCIe endpoints may be coupled to the root complex 104 through the PCIe switch circuit 106. In the present description components or devices of a computing system form the nodes of the computing system. Components or devices of the computing system may for example be processors, memory, interfaces, etc.

The root complex 104 may be coupled to the processor 102 using a proprietary local bus interface or a standards-defined local bus interface. The root complex 104 may control configuration and data transactions through the PCIe interfaces and may generate transaction requests for the processor 102. In some examples, the root complex 104 is implemented in the same Integrated Circuit (IC) device that includes the processor 102. The root complex 104 supports multiple PCIe links.

The root complex 104 may control communication across the PCIe link between the processor 102 and the multiple devices 110, 112-1, 112-2 . . . 112-N. The PCIe interface may support full-duplex communication between any two endpoints, with no inherent limitation on concurrent access across multiple endpoints. Data packets may carry information through any PCIe link. In a multi-lane PCIe link, packet data may be striped across multiple lanes. The number of lanes in the multi-lane link may be negotiated during device initialization and may be different for different endpoints. This negotiation is repeated each time that one of the PCIe links is reset.

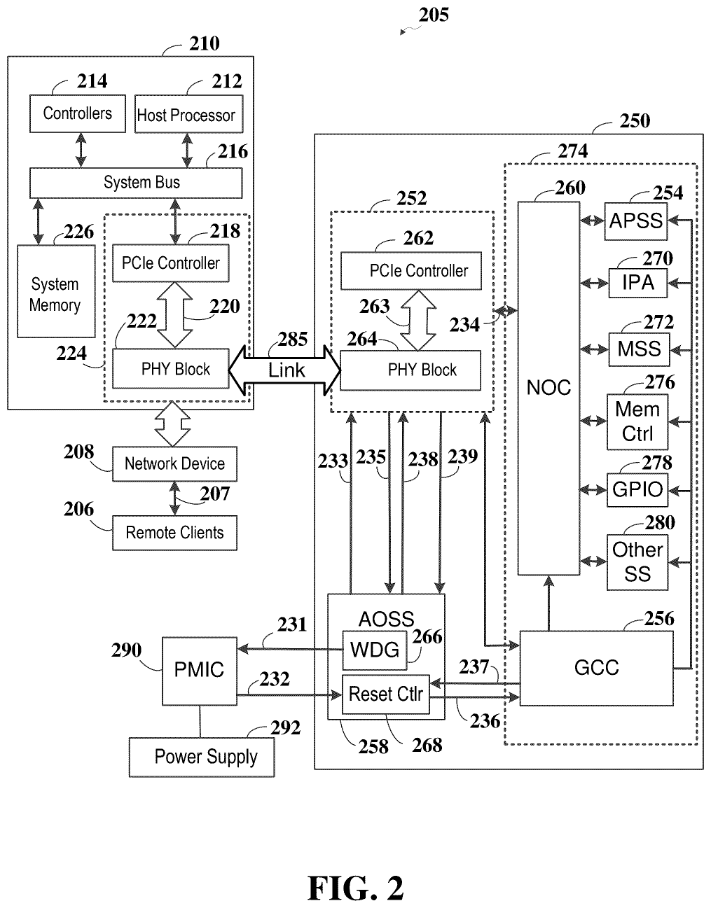

FIG. 2 is a block diagram of an exemplary PCIe system in which aspects of the present disclosure may be implemented. The system 205 includes a host 210 as a first node of a link 285 and a device 250 as a second node of the link 285. The host 210 is optionally coupled to one or more remote clients 206 through a network device 208 as a third node. The diagram shows only some features and components. A practical system may include many devices and the host and device may include many more or fewer components than shown. The host 210 may be integrated on a first chip (e.g., system-on-chip or SoC), and the device 250 may be integrated on a second chip. In another aspect, the host and/or device may be integrated in first and second packages, e.g., SiP, first and second system boards with multiple chips, or in other hardware or any combination. In this example, the host 210 and the device 250 are coupled by a single PCIe link 285. There may be many more devices coupled though other PCIe links. The PCIe link may be formed with wire leads, conductive traces, socket and plug, or cables.

The present description is provided in the context of a host, as one node, connected through a PCIe link to a device as a second node. A third node, a network device 208, is also coupled to the first node, the host, through a PCIe link. While the processes and structures described herein are well suited to the particular features and characteristics of PCIe, these particular features and characteristics are not required to realize the benefits described herein. Other links may be used instead of PCIe to connect one or more nodes. In addition, other types of nodes than the host and devices as described herein may be used instead to be connected through a link, whether a PCIe link or another link.

The host 210 also includes a host processor 212 acting as an application processor for the host 210 that is coupled to a system bus 216. The host processor may also perform at least some root complex functions. The host processor 212 may be implemented on a central processing unit executing software that performs the functions of the host processor 212 discussed herein. The host 210 includes one or more controllers 214, e.g., I/O controllers, memory controllers, sensor controllers, thermal controllers, network controllers, etc. also coupled to the system bus 216. Each of the one or more controllers 214 may be implemented on a processor executing software that performs the functions of the controllers 214 discussed herein.

The host 210 includes a PCIe Root Complex (RC) 224 and host system memory 226, each coupled to the system bus 216. The system bus 216 may interface the one or more controllers 214 with the host processor 212, and interface each of the one or more controllers 214 and the host processor 212 with the RC 224 and the host system memory 226. The RC 224 provides the host 210 with an interface to the PCIe link 285. In this regard, the RC 224 is configured to transmit data (e.g., from the host processor 212 and controllers 214) to the device 250 over the PCIe link 285 and receive data from the device 250 via the PCIe link 285. The RC 224 includes a PCIe controller 218, and a physical (PHY) block 222 to transmit and receive data through the PCIe link 285. The PCIe controller 218 and PHY block 222 are connected via a connection 220. The PCIe controller 218 (which may be implemented in hardware) may be configured to perform transaction layer, data link layer, and control flow functions, etc.

The host 210 is coupled through the RC 224 to a local network device 208, e.g., a network adapter card, or Ethernet controller, etc. The local network device is coupled to one or more remote clients 206 through a network 207, e.g., a local area network, wide area network, or the Internet. The remote clients 206 may communicate with the host 210 through any of a variety of different interfaces, including an Application Programming Interface (API) to make requests and perform other interactions with the host 210.

The device 250 includes one or more application processor sub-systems (APSS) 254. Each APSS 254 may be implemented on a processor executing software that performs the functions of the APSS 254 discussed herein. For the example of more than one APSS 254, each APSS 254 may be implemented on the same processor or different processors. The APSS may also be configured to receive bandwidth request(s) from one or more device components and to determine whether to change the number of active lanes or to change the speed based on bandwidth requests. The APSS 252 may be implemented on a processor executing software that performs the functions of a device controller.

The device 250 includes a PCIe Endpoint (EP) 252, a Network on Chip (NOC) Interface 260, coupled to the EP 252, the APSS 254 coupled to the NOC Interface 260, an Internet Protocol Accelerator (IPA) 270 coupled to the NOC Interface 260, a modem sub-system (MSS) 272 coupled to the NOC Interface 260, a memory controller 276 coupled to the NOC 260, General Purpose Input/Output (GPIO) 278 coupled to the NOC 260, and one or more other subsystems 280 coupled to the NOC 260. The IPA 270 provides hardware accelerated processing of Internet Protocol (IP) packets through the EP 252. The MSS 272 facilitates external wireless or wired communication from the device 250 through a modem and may represent Ethernet, Universal Serial Bus, Bluetooth, Wi-Fi, cellular, fiber optic, or any other suitable communication system. The memory controller 276 provides access to an internal or external memory, e.g., DRAM, RAM, or mass storage, and manages the operation of the memory. The GPIO allows for input and output at low data rates for a variety of remote devices. The particular types and number of subsystems may be adapted to the intended functions of the device 250. More or fewer or different sub-systems may be used to suit the capabilities and uses of the device 250. The NOC Interface 260 may interface any of the other connected components to the APSS 254, and interface each of the coupled components with the EP 252.

The EP 252 provides the device 250 with an interface to the PCIe link 285. In this regard, the EP 252 is configured to transmit data to the host 210 over the PCIe link 285 and receive data from the host 210 via the PCIe link 285. The EP 252 includes a PCIe controller 262, and a PHY block 264 for both receive and transmit. The PCIe controller 262 and PHY block 264 are connected via a connection 263. The PCIe controller 262 (which may be implemented in hardware) may be configured to perform transaction layer, data link layer and control flow functions.

The PHY block 222 of the RC 224 serializes parallel data from the PCIe controller 218 and drives the PCIe link 285 with the serialized data. The PHY block 222 may include one or more serializers and one or more drivers. At the device 250, the PHY block 264 receives the serialized data via the PCIe link 285, and deserializes the received data into parallel data. In this regard, the PHY block 264 may include one or more receivers and one or more deserializers. The PHY block 264 transfers the deserialized data to the PCIe controller 262. The PCIe controller 262 may recover the data from the host 210 from the deserialized data and forward the recovered data to one or more device APSS 254 through the NOC Interface 260. A reciprocal transaction is performed to send data from the EP 252 to the RC 224 through the PHY block 264.

The device 250 also includes a Global Clock Controller (GCC) 256 that may include or be coupled to an oscillator (e.g., crystal oscillator) and which is configured to generate a stable reference clock signal for components of the device. In some aspects, a clock generator (not shown) at the host 210 is configured to generate a stable reference clock signal, which is forwarded to the device 250 via a differential clock line to the device 250 or via a part of the link 285 to the PHY block 264. At the device 250, the PHY block 264 forwards the received clock as an EP reference clock signal to the GCC 256. The GCC 256 is configured to generate multiple clock signals based on the received clock signal and to forward these clock signals to the other components of the device 250 as shown. In this regard, the GCC 256 may include multiple phase-locked loops (PLLs), in which each PLL generates a respective one of the multiple clock signals by multiplying up the frequency of the EP reference clock signal.

The device 250 also includes or is coupled to a power management integrated circuit (PMIC) 290 coupled to a power supply 292 e.g., mains voltage, a battery, or other power source. The PMIC 290 is configured to convert the voltage of the power supply 292 into multiple supply voltages (e.g., using switch regulators, linear regulators, or any combination thereof). The PMIC 290 may be implemented on one or more chips. Although the PMIC 290 is shown as one PMIC, the PMIC 290 may be implemented by two or more PMICs that may both be coupled to the same power supply 292 or to different power supplies. The same PMIC may be configured to provide power to the host 210. The PMIC 290 provides power directly or indirectly to all of the components of the device 250. These connections are not shown. The network device 208 may include one or more of the components described for the device 250 including an EP to provide an interface to the RC 224.

The device 250 includes an SoC 274 which includes some or all of the components of the device 250 other than the EP 252, e.g., the NoC Interface 260, and the components connected to the NoC Interface 260, e.g., the GCC 256, the APSS 254, the MSS 272, the IPA 270, and other components not shown. The SoC 274 performs the processing and input/output functions requested by the remote clients 206, e.g., through an API to the host 210. The SoC 274 delivers results through the EP 252 to the host 210. The device 250 may include more or fewer components than shown. In some examples, the EP 252 may be a subsystem on the same die as the APSS 254, NOC Interface 260 and other components. In some examples, the EP 252 may be formed on a separate die or chiplet from the SoC 274 but referred to as being a part of the same system. The EP 252 is shown and described as a separate subsystem from the SoC 274 for purposes of clarifying the operations and may or may not be physically separate from the SoC 274.

The PMIC 290 is coupled to an always on sub-system (AOSS) 258 which includes a watchdog timer (WDG) 266 and a reset controller 268. It may also include other components not shown here. The AOSS 258, or at least a portion of the AOSS 258 operates when power is available notwithstanding the operational or active status of the SoC 274. It operates when any system client is awake and during the standby and reset states of SOC 274. This allows the AOSS 258 to drive a reset process on the SoC 274 and EP 252. The AOSS 258 is not shown as included in the SoC 274 because it is always on and not reset in the described reset process. In some examples, the AOSS 258 may also have sleep states to support ultra-low power modes. These sleep states and low power modes are not used in the described reset process. In some examples, the AOSS 258 is a physical part of the SoC 274.

A reset process may be initiated by a signal from the host 210 through the PCIe link 285, by a signal from the WDG 266, or in another way. The reset signal is received at and then driven by the reset controller 268 of the device 250. In some aspects, the host 210 requests a reset of the device 250 after a remote client 206 is finished using the device. The reset process prepares the SoC 274 for the next remote client 206. Before the SoC reset, the AOSS 258 first ensures that the EP 252 is awake, i.e., in an active state. In some aspects, the EP 252 has a separate wakeup sequence that is independent of the SoC 274. In some implementations, the EP may be in an L1 or L2 low power state and then be awakened through a wakeup sequence to an L0 or LOp state. In some aspects, the EP 252 and the SoC 274 are activated through a single wakeup sequence. As an example, there may be a common power rail for both the EP 252 and the SoC 274 so that a sleep exit wakes both components. After waking the EP 252, the SoC 274 is disconnected from the EP 252 and the SoC 274 is reset. The reset process is described in more detail below. After the SoC reset, the SoC 274 is reconnected to the EP 252.

The reset process may include various signaling between the PMIC 290, the AOSS 258, the EP 252 and the SoC 274. Seven signals are shown, although there may be more or fewer. As mentioned, the host 210 can request the reset of the device 250 via the PCIe link 285 or a reset may be initiated in another way. After ensuring that the EP 252 is awake or in an active state, then the AOSS 258 starts the reset process in response to the reset request, e.g., from the host 210. The AOSS 258 drives a power supply hold (PS_HOLD) signal 231 to the PMIC 290. In some aspects, this is a pin on the PMIC 290 that the AOSS 258 can drive high to assert the PS_HOLD signal 231.

In response to the PS_HOLD signal 231, the PMIC 290 triggers a warm reset. The PMIC 290 drives a reset input (RESIN) signal 232 to the AOSS 258. In some aspects, the reset input signal is generated by pulling a pin of the reset controller to an active low state. The reset input signal is de-asserted by releasing the pin, allowing it to float, or driving it high. In another aspect, the reset input signal may be generated in the form of a command, writing to a configuration register or in another way. In some aspects, the reset input signal 232 is received at the reset controller 268 of the AOSS 258 for processing. There may be an SOC disconnect/reconnect state machine in the AOSS reset controller 268 that works with the GCC 256 and an EP state machine to ensure that any requests from the host 210 through the PCIe link 285 during the reset are handled in a graceful manner. In some aspects, an activity timer is set, e.g., at the WDG, in response to the reset input signal 232.

In response to the reset input signal 232, the AOSS 258 initiates a handshake with the EP 252 to disconnect the EP 252 from the SoC 274. In some aspects, this handshake comes from the reset controller 268. The AOSS sends e.g., a disconnect request (SoC_disconnect_req) signal 233 to the EP 252. To perform the disconnection from the SoC, the EP 252 may perform any of a variety of different operations. In some aspects, the EP 252 may stop accepting outbound requests. Any required response from the host may be answered with dummy data as a reply on the peripheral component link, e.g., link 285. The PCIe controller may contain a register to store or a number generator to generate dummy data that is then provided to the PHY block 264 when needed. Any received data to the NoC is blocked and any pending write requests from the NoC to the link 285 are completed. In some aspects, the EP is driven by a system clock of the device 250 that also drives the SoC 274. To isolate the EP 252 from the SoC reset, the EP 252 may then switch to a different clock, e.g., a PCIe controller core clock, a port clock received via the link 285 or an auxiliary clock.

The EP 252 disconnects 234 from the SoC 274, e.g., by disconnecting from the NoC Interface 260. The EP then acknowledges the AOSS handshake by sending a disconnect acknowledgment (SoC_disconnect_ack) signal 235 back to AOSS 258, e.g., the reset controller 268. In the meantime, the EP 252 stays active and presents as active to the RC 224 through the link 285. In this way the link 285 is maintained and is not reset. In the event that the reset controller 268 does not receive the disconnect acknowledgment signal 235 from the EP 252 before the activity timer expires, then there may be an error or hang at the EP 252. In this case, the reset controller may reset the EP 252 together with the SoC 274. This will require the link 285 to be suspended but will restore the EP 252 to a valid active status together with the SoC 274.

After the EP 252 is disconnected from the SoC 274, the AOSS 258 asserts a reset signal 236 for the SoC 274. This reset includes all of the components that are suitable for the nature of the reset. The SoC reset may be initiated by sending the reset signal 236 from the reset controller 268 to the GCC 256, as shown, or in another suitable way. In some aspects the reset is a warm reset. The SoC 274 is warm in that it is in an active state before receiving the reset signal 236. In some aspects, the active state is referred to as the Mission Mode. The warm reset for the SoC 274 may be provided when the power supplied by the PMIC 290 for the SoC 274 was not toggled by the PMIC 290 in response to the PS_HOLD signal 231 that was asserted before the reset input signal 232 was asserted. First, the reset controller 268 wakes the SoC 274 and, in particular, the APSS 254 before starting the reset. This may be performed in some implementations by commanding a wakeup sequence as a wake command from the reset controller 268 through the GCC 256 and the NoC Interface 260. If the SoC is in a wake state before receiving the wake command, then the wake command may be ignored by the SoC so that it will not affect the SoC 274. However, if it is not awake, then the SoC 274 will transition to an active state. In either event, the active state will be confirmed to the reset controller 268. After having this confirmation, the reset controller 268 will send the reset signal 236.

As mentioned above, during this warm reset, the PCIe logic is disconnected from the SoC and stays operational. In other words, the PCIe link 285 between the host 210 and the device 250 is active and is able to send and receive data and control information with the host 210. The PCIe link 285 may continue to be used and is unaffected by the warm reset. Any requests received from the host 210 through the RC 224 may be answered with dummy data. Received data may be buffered or discarded when the buffer is full.

After the SoC 274 completes the reset, the GCC 256 may send an active status 237 to the reset controller 268. In response to the active status, the EP 252 may be reconnected to the SoC 274. The SoC 274 upon initialization may initialize all of its clocks and also initialize the clocks for the IPA 270 via the GCC 256. Upon receiving the active status 237, the reset controller 268 may send a reconnection request (SoC_connect_req) signal 238 to the EP 252. In some aspects, an activity timer is set when the reconnection request signal 238 is sent.

The EP 252 may then reconnect to the SoC 274, e.g., at the NoC Interface 260. This may include switching the NoC ports to the original clock, e.g., switching the EP from the core, host, or auxiliary clock to the PCIe core clock. The EP 252 will also start to receive and send data through the link 285. After the EP 252 has successfully reconnected then it may respond to the reset controller with a reconnection acknowledgment (SoC_connect_ack) signal 239 to the reset controller 268 of the AOSS 258.

After the SoC 274 is reset and the EP 252 is reconnected to the SoC 274, any further request from the host 210 may then be answered by the device 250 with real data. The PCIe link 285 was maintained throughout the process so that there is no need to re-initialize the PCIe link 285 and the reset process at the SoC 274 does not affect any other device or EP coupled to the RC 224. If the reset controller 268 does not receive the reconnection acknowledgment signal 239 before the activity timer expires, then the EP reset may be repeated to bring the EP 252 to a stable and responsive state. The operations may include additional operations and components not mentioned above.

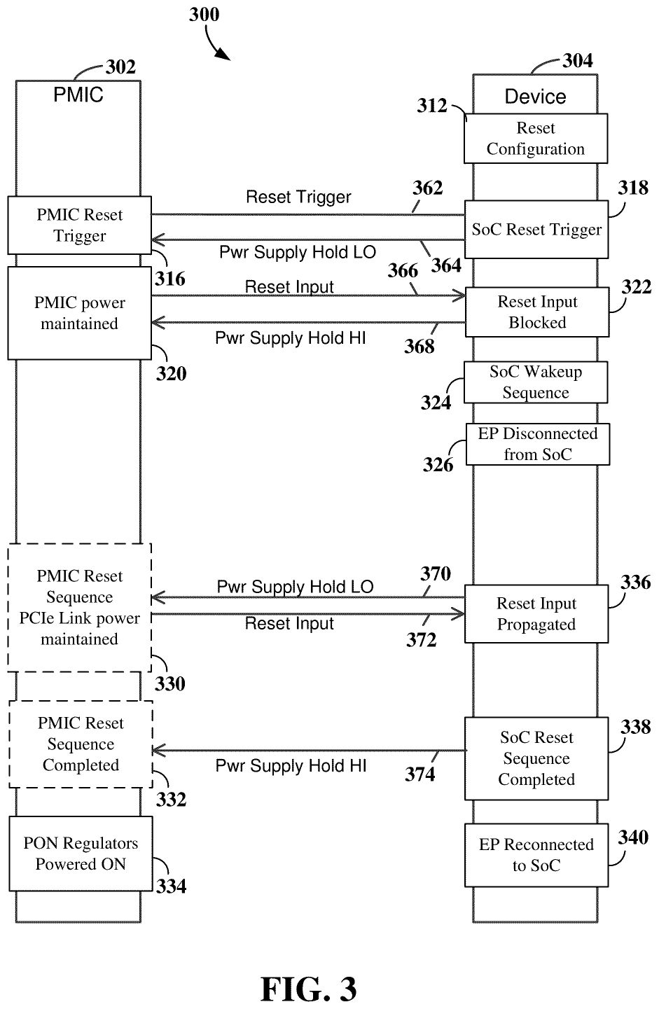

FIG. 3 is a process and signal diagram 300 of the warm reset operations between a power supply and a device, including a reset controller and an SOC. In some aspects, the PMIC 302 is physically incorporated into the device 304. At the device 304, the warm reset configuration 312 is loaded or established. The specific configuration may be modified to suit different implementations. In one configuration, the device may have top level control/status registers in the AOSS or the reset controller to enable the reset process to track the sleep or active state of the EP and to track sleep or active state of the SoC, e.g., a two-bit register may be used to track the state of the SoC as standby, low power, active, etc.

A reset process may be initiated by a reset trigger 362. The reset trigger 362 may originate from a host, an internal timer, or from any of a variety of sensed conditions of the SoC, e.g., temperature, memory error, unstable output, missing instruction, etc. The reset trigger 362 is shared or sent between the components of the system resulting in a PMIC reset trigger 316 and an SoC reset trigger 318. In response to the reset trigger 362, the device, e.g., the reset controller, pulls a power supply hold line low 364. The power supply hold line low 364 is a signal from the SoC to indicate that the SoC has some problem or that the SoC is to go through a reset process. In response to the power supply hold line low 364, the PMIC 302 generates a reset input 366 to the device. The reset input 366 is a signal to reset the SoC. The PMIC maintains power to all of the components in preparation for the SoC reset at 320. The device, however, blocks this reset input at 322 and then switches to pull the power supply hold high 368. The power supply hold high 368 indicates that the SoC power state is good. The power supply hold high 368 causes the PMIC 302 to stop asserting the reset input 366. When the PMIC stops asserting the reset input 366, the device 304 is able to configure the state of the device 304 in preparation for the reset from the PMIC. In particular, the device 304 can ensure a warm reset which enhances the stability of the device 304 upon reset.

The operation of blocking the reset input 366 is optional. In some configurations, the reset controller will isolate some of the sub-systems of the SoC before propagating the reset to the SoC. The particular sub-systems to isolate and maintain may be selected to suit the intended use of the device. As examples, particular types of memory controller, or GPIO may be maintained in an active state during the SoC reset. The EP will also be maintained in an isolated state as indicated at 320.

While the reset input is blocked, the device 304 e.g., using the reset controller, initiates a wakeup sequence 324 for the SoC if the SoC is in a low power state. It also disconnects the EP from the SoC at 326. Other operations may be performed to enhance the speed, efficiency, and effectiveness of the SoC reset. Having performed these operations, the power supply hold low 370 is reasserted from the device 304 to the PMIC 302. The PMIC then reasserts the reset input 372. The device then propagates the reset input at 336 and begins the SoC reset. After the SoC reset sequence is completed at 338, then the EP is reconnected to the SoC at 340. A new power supply hold high 374 may be asserted by the device after the SoC reset sequence is initiated at 324. This may be done by boot software at the SoC or by the SoC after the reset is completed as shown. Pulling this signal high stops the PMIC from asserting another reset input.

The SoC wakeup sequence at 324 ensures that the SoC is likely in a stable state and able to perform an accurate reset. The disconnect at 326 and reconnect at 338 of the EP from and to the SoC improves the device availability. This allows the PCIe link through the EP to be maintained through the SoC reset sequence. As a result, the PCIe link is not reset, and delay caused by waiting to reset the PCIe link is avoided. Any related PCIe links to other devices are also not affected by a PCIe link reset.

At the PMIC, after the reset input 372 is reasserted, the PMIC is optionally able to perform its own wakeup sequence at 330. During this sequence power to at least a portion of the EP is maintained. In addition, power to particular subsystems of the SoC may be maintained. In some examples, the PMIC resets the PMIC subsystems. The PMIC completes the wakeup sequence at 332 and the Power ON (PON) regulators are powered on at 334. Additional power regulators may be turned on by software or drivers as the system continues the startup sequences.

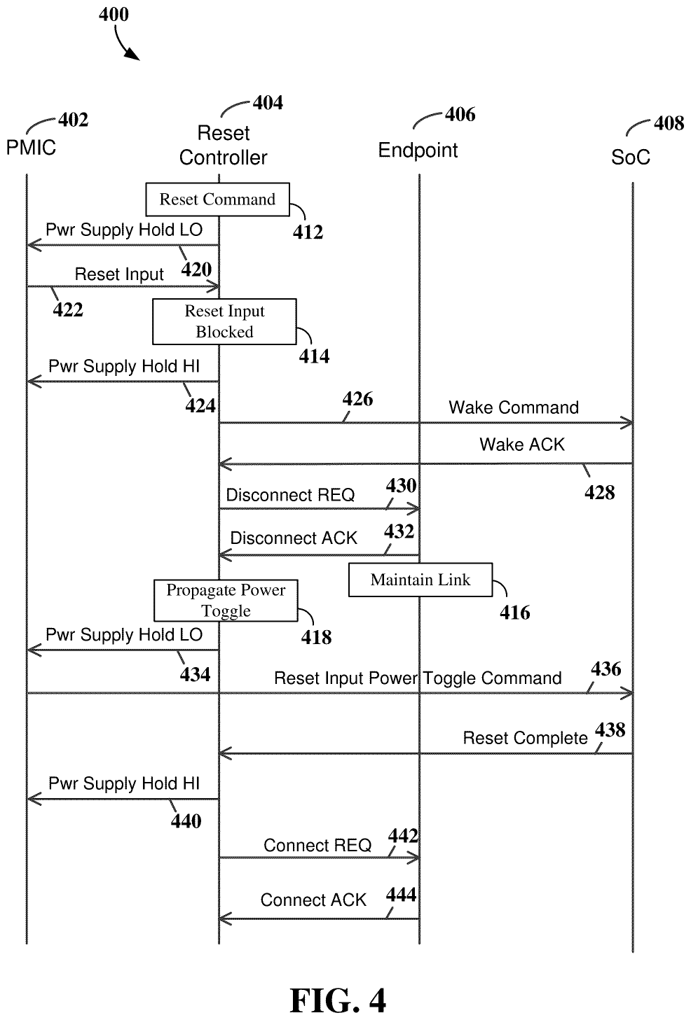

FIG. 4 is a signal diagram 400 of a warm reset operation as controlled by a reset controller at a device. The reset controller 404 is a part of a device that also includes an endpoint 406 and SoC 408. A PMIC 402 may be a part of the device or coupled to the device. The endpoint 406 is configured to maintain a link between the device as one node of the link and a host as another node of the link. The reset controller 404 receives a reset command 412 from a host, a timer, an SoC process or another source. The reset controller 404 sends a power supply hold command 420 to the PMIC 402 in response to the reset command. In some aspects the power supply hold command 420 indicates that the SoC is to perform a reset, e.g., to support a new client. The PMIC 402 returns a reset input command 422 to the reset controller 404 in response to the power supply hold command 420, however the reset controller 404 blocks it at 414. This prevents the reset input command 422 from being propagated to the endpoint 406 and to the SoC 408. The reset controller then responds to the PMIC 402 with a power supply hold command 424 in which it pulls the pin high. The pulling the pin high indicates that the SoC power state is good, even though the power state may not be good, and stops the power toggle or reset input command 422.

After having optionally delayed the reset command 422 by blocking the command at 414 and asserting, power supply hold high 424, the reset controller 404 optionally wakes the SoC 408 before beginning the SoC reset. The reset controller 404 may initiate a wakeup sequence at the SoC 408 by sending a wake command 426 to the SoC 408. In some aspects, the reset controller 404 determines the state of the SoC and sends the wake command 426 when the SoC 408 is in a standby or low power state. When the SoC 408 has transitioned to an active state, then the SoC 408 sends a wake acknowledgment (ACK) 428. The wake command 426 ensures that the SoC 408 is in a stable state for reliable reset.

The reset controller 404 also sends a disconnect request (REQ) command 430 to the endpoint 406. The endpoint disconnects from the SoC 408 and then sends a disconnect ACK signal 432 back to the reset controller 404. The endpoint 406 maintains the link 416 while disconnected from the SoC 408. After the endpoint 406 is disconnected and the SoC 408 is in an active state, the SoC reset may start.

The reset controller 404 propagates a power toggle 418 from the PMIC. This may be done, for example, by pulling the power supply hold 434 to the PMIC 402 low. The PMIC responds with a reset input or power toggle which acts as a reset input command 436 to the SoC 408. In another aspect, in the example described in the context of FIG. 2 in which the PMIC 290 drives a reset input signal 232 to the reset controller 268 of the AOSS 258 which then asserts a reset signal 236 from the AOSS 258 to the SoC 274. The propagation of the reset input signal and other signals may be modified to suit different implementations. The SoC 408 performs a reset and then responds with a reset complete signal 438. The reset complete signal 438 may be a part of a wakeup sequence, an explicit signal, or activity on a network.

After receiving a reset complete signal 438, the reset controller 404 pulls the power supply hold 440 to the PMIC 402 high which operates as a block on any power toggle and ends the reset input command 436. The reset controller also sends a connection REQ 442 to the endpoint 406. Upon receiving a connect ACK signal 444 from the endpoint, the device is reset and ready to perform operations for a next client or for any other suitable purpose.

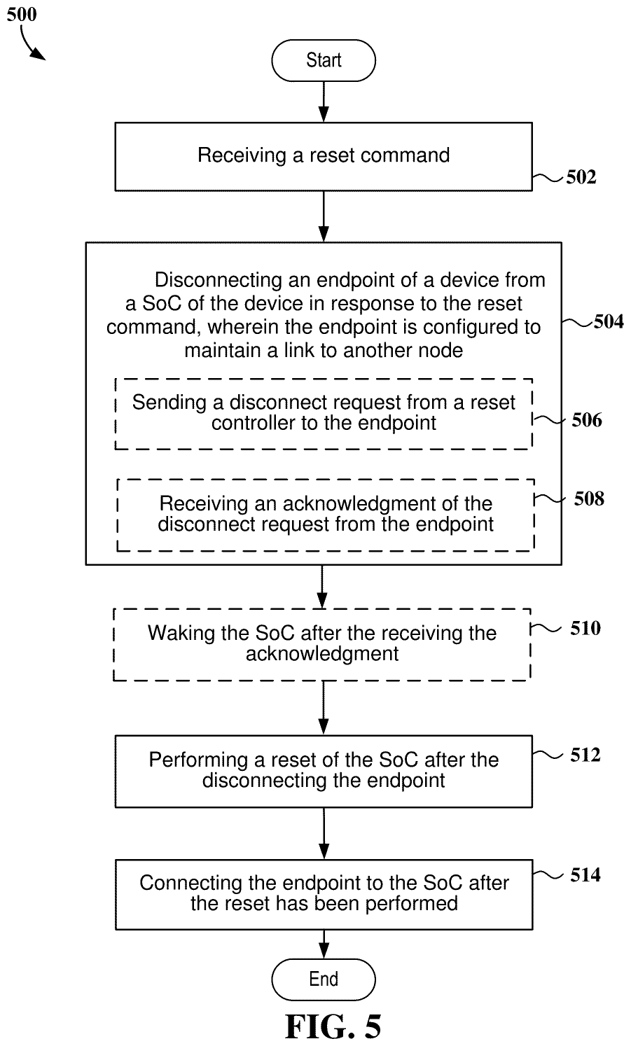

FIG. 5 is a process flow diagram 500 of a method of a device reset as described herein. Optional operations of the process flow diagram are identified with boxes having dashed lines. At the start, there may be a system configuration and an initiation of parameters. At 502 receiving a reset command is performed. The device may be a node of a link, e.g., a PCIe link. In some examples, the reset is received at a reset controller of the device. The reset command may be received from a host through the link, a local or external timer, an SoC or another source. In some examples, the reset controller is a component of an always-on sub-system. The always on sub-system of the device may be active during standby and reset states of the SoC.

At 504, disconnecting an endpoint of the device from a system-on-a-chip (SoC) of the device is performed in response to the reset command, wherein the endpoint is configured to maintain the link to another node, e.g., a host of a PCIe link. In some examples, the endpoint is disconnected by sending a disconnect request from the reset controller to the endpoint.

At 506, the disconnecting the endpoint of the device from the SoC of the device may optionally comprise sending a disconnect request from a reset controller to the endpoint.

At 508, the disconnecting the endpoint of the device from the SoC of the device may further optionally comprise receiving an acknowledgment of the disconnect request from the endpoint. The acknowledgment may be received in response to the sending the disconnect request. The endpoint may perform additional operations in preparation for the disconnection, e.g. stop accepting outbound requests, stop forwarding doorbells to a NoC, complete all pending NoC transactions, and switch to an auxiliary clock.

At 510, waking the SoC after the receiving the acknowledgment is optionally performed. In some aspects waking the SoC is performed without receiving the acknowledgment. In some aspects, the reset controller initiates a wakeup sequence through sending a command from the reset controller. The reset controller may also block a power toggle from a power management integrated circuit to the SoC during a wakeup sequence and pass the power toggle after the wakeup sequence.

The operation at 512 includes performing a reset of the SoC after the disconnecting the endpoint and optionally after the wakeup sequence at the SoC is completed. In some aspects, the reset of the SoC is performed also after receiving an acknowledgment of the disconnect request. The reset controller may send a reset command to a clock controller of the SoC. A power toggle may be sent from a power management integrated circuit coupled to the SoC while maintaining power to the endpoint during the performing the reset.

The operation at 514 includes connecting the endpoint to the SoC after the reset has been performed.

The following provides an overview of examples of the present disclosure.

Example 1: An apparatus comprising: an endpoint of a device configured to maintain a link to another node and to receive a reset command; a reset controller configured to disconnect the endpoint of the device from a system-on-a-chip (SoC) of the device, to command a reset of the SoC after the disconnecting the endpoint, and to connect the endpoint to the SoC after the reset has been performed.

Example 2: The apparatus of example 1, further comprising a power management integrated circuit (PMIC) configured to trigger the reset to the SoC through the reset controller and to provide power to the endpoint while the reset is being performed.

Example 3: The apparatus of example 2, wherein the reset controller is configured to send a power supply hold signal to the PMIC in response to the trigger of the reset of the SoC.

Example 4: The apparatus of example 1, 2, or 3, further comprising a controller of the endpoint configured to send dummy data through the link while the reset is being performed.

Example 5: An apparatus comprising means for disconnecting an endpoint of a device from a system-on-a-chip (SoC) of the device in response to receiving a reset command, wherein the endpoint is configured to maintain a link to another node; means for performing a reset of the SoC after the disconnecting the endpoint; and means for connecting the endpoint to the SoC after the reset has been performed.

Example 6: The apparatus of example 5, further comprising means for waking the SoC before performing the reset.

Example 7: A method comprising: receiving a reset command; disconnecting an endpoint of a device from a system-on-a-chip (SoC) of the device in response to the reset command, wherein the endpoint is configured to maintain a link to another node; performing a reset of the SoC after the disconnecting the endpoint; and connecting the endpoint to the SoC after the reset has been performed.

Example 8: The method of example 7, wherein the receiving the reset command comprises receiving the reset command at a reset controller of the device.

Example 9: The method of example 8, wherein the reset controller is a component of an always-on sub-system.

Example 10: The method of any one or more of examples 7-9, wherein the receiving the reset command comprises receiving the reset command from a host through the link.

Example 11: The method of any one or more of examples 7-10, wherein the receiving the reset command comprises receiving the reset command from a timer.

Example 12: The method of any one or more of examples 7-11, wherein the disconnecting the endpoint comprises sending a disconnect request from a reset controller to the endpoint and receiving a disconnect acknowledgment from the endpoint at the reset controller, and wherein the performing the reset of the SoC comprises performing the reset after the receiving the disconnect acknowledgment.

Example 13: The method of any one or more of examples 7-12, wherein the performing the reset comprises sending a reset command to a clock controller of the SoC.

Example 14: The method of any one or more of examples 7-13, wherein the performing the reset comprises sending a reset command from a power management integrated circuit coupled to the SoC to the SoC.

Example 15: The method of any one or more of examples 7-14, further comprising maintaining power to the endpoint during the performing the reset.

Example 16: The method of any one or more of examples 7-15, further comprising waking the SoC before the performing the reset.

Example 17: The method of any one or more of examples 7-16, wherein the waking the SoC comprises sending a wakeup command from the reset controller.

Example 18: The method of any one or more of examples 7-18, wherein the waking the SoC comprises blocking a reset command from a power management integrated circuit to the SoC during a wakeup sequence and sending the reset command after the wakeup sequence.

Example 19: The method of any one or more of examples 7-18, wherein the endpoint is configured to maintain the link by sending dummy data as a reply on the link.

Example 20: The method of any one or more of examples 7-19, wherein the reset controller is a component of an always on sub-system of the device that is active during the performing the reset of the SoC.

It is to be appreciated that the present disclosure is not limited to the exemplary terms used above to describe aspects of the present disclosure. E.g., bandwidth may also be referred to as throughput, data rate or another term.

Although aspects of the present disclosure are discussed above using the example of the PCIe standard, it is to be appreciated that present disclosure is not limited to this example and may be used with other standards.

The host processor 212, the controllers 214, the APSS 254, the AOSS 258 and other components discussed above may each be implemented with a controller or processor configured to perform the functions described herein by executing software including code for performing the functions. The software may be stored on a non-transitory computer-readable storage medium, e.g., a RAM, a ROM, an EEPROM, an optical disk, and/or a magnetic disk, shows as host system memory 226, endpoint system memory (of the APSS 254 and otherwise), or as another memory.

Any reference to an element herein using a designation e.g., “first,” “second,” and so forth does not generally limit the quantity or order of those elements. Rather, these designations are used herein as a convenient way of distinguishing between two or more elements or instances of an element. Thus, a reference to first and second elements does not mean that only two elements can be employed, or that the first element must precede the second element.

Within the present disclosure, the word “exemplary” is used to mean “serving as an example, instance, or illustration. ” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect electrical or other communicative coupling between two structures. Also, the term “approximately” means within ten percent of the stated value.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. An apparatus comprising:
an endpoint of a device configured to maintain a link to another node;
a reset controller configured to disconnect the endpoint of the device from a system-on-a-chip (SoC) of the device in response to a reset trigger, to command a reset of the SoC after the disconnecting the endpoint, and to connect the endpoint to the SoC after the reset has been performed.

2. The apparatus of claim 1, further comprising a power management integrated circuit (PMIC) configured to trigger the reset to the SoC through the reset controller and to provide power to the endpoint while the reset is being performed.

3. The apparatus of claim 2, wherein the reset controller is configured to send a power supply hold signal to the PMIC in response to the trigger of the reset of the SoC.

4. The apparatus of claim 1, further comprising a controller of the endpoint configured to send dummy data through the link while the reset is being performed.

5. An apparatus comprising:
means for disconnecting an endpoint of the device from a system-on-a-chip (SoC) of the device in response to a reset command, wherein the endpoint is configured to maintain a link to another node;
means for performing a reset of the SoC after the disconnecting the endpoint; and
means for connecting the endpoint to the SoC after the reset has been performed.

6. The apparatus of claim 5, further comprising means for waking the SoC before performing the reset.

7. A method comprising:
receiving a reset command;
disconnecting an endpoint of a device from a system-on-a-chip (SoC) of the device in response to the reset command, wherein the endpoint is configured to maintain a link to another node;
performing a reset of the SoC after the disconnecting the endpoint; and
connecting the endpoint to the SoC after the reset has been performed.

8. The method of claim 7, wherein the receiving the reset command comprises receiving the reset command at a reset controller of the device.

9. The method of claim 8, wherein the reset controller is a component of an always-on sub-system.

10. The method of claim 7, wherein the receiving the reset command comprises receiving the reset command from a host through the link.

11. The method of claim 7, wherein the receiving the reset command comprises receiving the reset command from a timer.

12. The method of claim 7,
wherein the disconnecting the endpoint comprises sending a disconnect request from a reset controller to the endpoint and receiving a disconnect acknowledgment from the endpoint at the reset controller, and
wherein the performing the reset of the SoC comprises performing the reset after the receiving the disconnect acknowledgment.

13. The method of claim 7, wherein the performing the reset comprises sending a reset command to a clock controller of the SoC.

14. The method of claim 7, wherein the performing the reset comprises sending a reset command from a power management integrated circuit coupled to the SoC to the SoC.

15. The method of claim 7, further comprising maintaining power to the endpoint during the performing the reset.

16. The method of claim 7, further comprising waking the SoC before the performing the reset.

17. The method of claim 16, wherein the waking the SoC comprises sending a wakeup command from the reset controller.

18. The method of claim 16, wherein the waking the SoC comprises blocking a reset command from a power management integrated circuit to the SoC during a wakeup sequence and sending the reset command after the wakeup sequence.

19. The method of claim 7, wherein the endpoint is configured to maintain the link by sending dummy data as a reply on the link.

20. The method of claim 7, wherein the reset controller is a component of an always on sub-system of the device that is active during the performing the reset of the SoC.
